(19) United States
(12) Patent Application Publication
(10) Pub. No.: US 2015/0222497 A1
(43) Pub. Date: Aug. 6, 2015

(54) INFORMATION TERMINAL, INFORMATION DISPLAY METHOD, CONTROL PROGRAM AND SERVER

(71) Applicant: Panasonic Intellectual Property Management Co., Ltd., Osaka-shi, Osaka (JP)

(72) Inventors: Yasuo Yoshimura, Shiga (JP); Kenichi Kamon, Shiga (JP)

(21) Appl. No.: 14/420,292

(22) PCT Filed: Jul. 30, 2013
(86) PCT No.: PCT/JP2013/004602

§ 371 Date: Feb. 6, 2015

(30) Foreign Application Priority Data
Aug. 7, 2012 (JP) 2012-174660

(51) Int. Cl. H04L 12/24; H04L 12/26; H04W 8/24; G06F 3/0482

(52) U.S. Cl. CPC H04L 41/22; G06F 3/0482; H04L 43/10; H04W 8/24

(57) ABSTRACT

An information terminal is provided with a wireless communication unit which performs proximity communication with an electronic tag provided in an electrical appliance and acquires menu creation information created in accordance with a state of the electrical appliance; a menu creation unit which creates menu information relating to an operation of the electrical appliance or relating to a service of the electrical appliance, based on the menu creation information acquired by the wireless communication unit; and a display unit which displays the menu information created by the menu creation unit.

### TECHNICAL FIELD

The present invention relates to an information terminal which displays a state of an appliance and controls an operation of the appliance, an information display method for displaying menu information relating to an operation of an appliance or relating to a service of the appliance, a control program for an information terminal which displays a state of an appliance and controls an operation of the appliance, and a server for communicating with an information terminal which displays a state of an appliance and controls an operation of the appliance.

### BACKGROUND ART

Conventionally, there is known a system which performs proximity communication between an appliance and a display device with use of an RF tag, and displays information of the appliance on a display device.

For instance, patent literature 1 discloses an appliance connection support system, in which an RF tag is provided in a video appliance, and an RF reader is provided in a television receiver (display device).

Individual information of the video appliance is stored in the RF tag. When the RF reader detects the RF tag by proximity communication, a connection recommendation method of the video appliance is displayed on a liquid crystal display of the television receiver.

According to this configuration, performing proximity communication by allowing the user to hold the video appliance to be connected close to the television receiver makes it possible to identify the video appliance, and to display a connection recommendation method. Thus, the user can easily connect the video appliance to the television receiver, even if the user does not fully know the connection method of the television receiver.

In patent literature 1, an information terminal provided with a display unit may be used, in place of a television receiver. Performing proximity communication between the information terminal and the appliance makes it possible to display setting information or operation information of the appliance on the information terminal so that the user is notified of the information. This makes it easy for the user to acquire information of the video appliance by proximity communication.

Further, providing an RF tag in each of a variety of types of appliances in addition to a video appliance, and performing proximity communication between an information terminal and the corresponding appliance by allowing the user to hold the information terminal close to the corresponding appliance makes it possible to display information relating to the appliance, and to control the operation of the appliance. The above configuration makes it easy for the user to acquire information of a variety of types of appliances by proximity communication with the variety of types of appliances.

An example of the information terminal is an appliance incorporated with a color touch panel screen, such as a smartphone. With use of the above technique, it is possible to provide the user with a user-friendly display and operation, which cannot be implemented by an appliance main body in which the information display function is poor.

The following matter, however, is involved in the above case. As the contents to be displayed on the information terminal and the contents to be set in the information terminal increase in order to meet the demands of a variety of types of appliances, the number of menus to be displayed on the information terminal increases, and the thickness of layers of menus increases. As a result, the operation becomes complicated, and the user's convenience may be impaired.

### CITATION LIST

### Patent Literature

Patent literature 1: JP 2007-043517 A

### SUMMARY OF INVENTION

In view of the above, an object of the invention is to provide an information terminal, an information display method, a control program, and a server that enable to enhance the user's operability.

An information terminal according to an aspect of the invention is an information terminal which displays a state of an appliance and controls an operation of the appliance. The information terminal is provided with a wireless communication unit which performs proximity communication with a proximity communication device provided in the appliance, and acquires menu creation information created in accordance with a state of the appliance; a menu creation unit which creates menu information relating to an operation of the appliance or relating to a service of the appliance, based on the menu creation information acquired by the wireless communication unit; and a display unit which displays the menu information created by the menu creation unit.

According to this configuration, menu information relating to an operation of the appliance or relating to a service of the appliance is created and displayed in accordance with a state of the appliance by proximity communication. This makes it easy for the user to operate the information terminal, and to enhance the user's operability.

These and other objects, features and advantages of the present invention will become more apparent upon reading the following detailed description along with the accompanying drawings.

### BRIEF DESCRIPTION OF THE DRAWINGS

FIG. 1 is a diagram illustrating an entire configuration of a wireless communication system according to an embodiment of the invention;

FIG. 2 is a first sequence diagram for describing an operation to be performed by the wireless communication system according to the embodiment of the embodiment;

FIG. 3 is a second sequence diagram for describing the operation to be performed by the wireless communication system according to the embodiment of the invention;

FIG. 4A is a diagram illustrating an example of a menu creation disable screen to be displayed when a power plug of an electrical appliance is not inserted in a power receptacle;

FIG. 4B is a diagram illustrating an example of a menu creation disable screen to be displayed when a power switch of the electrical appliance is not in an on-state;

FIG. 4C is a diagram illustrating an example of a menu creation disable screen to be displayed when the electrical appliance is in operation by the user;

FIG. 4D is a diagram illustrating an example of a menu creation disable screen to be displayed when the electrical appliance is in a standby state that the operation thereof is reserved;

FIG. 5A is a diagram illustrating an example of a menu screen to be displayed when the electrical appliance is in a standby state for operation settings, and the electrical appliance is a microwave oven;

FIG. 5B is a diagram illustrating an example of a menu screen to be displayed when the electrical appliance is in a standby state for operation settings and the electrical appliance is a rice cooker;

FIG. 5C is a diagram illustrating an example of a menu screen to be displayed when the electrical appliance is in a standby state for operation settings, and the electrical appliance is a washing machine;

FIG. 6A is a diagram illustrating an example of a menu screen to be displayed when the electrical appliance is under operation, and the electrical appliance is a microwave oven;

FIG. 6B is a diagram illustrating an example of a menu screen to be displayed when the electrical appliance is under operation, and the electrical appliance is a rice cooker;

FIG. 6C is a diagram illustrating an example of a menu screen to be displayed when the electrical appliance is under operation, and the electrical appliance is a washing machine;

FIG. 7A is a diagram illustrating an example of a menu screen to be displayed when the current time is within a predetermined time period after the operation of the electrical appliance is finished, and the electrical appliance is a microwave oven;

FIG. 7B is a diagram illustrating an example of a menu screen to be displayed when the current time is within a predetermined time period after the operation of the electrical appliance is finished, and the electrical appliance is a rice cooker;

FIG. 7C is a diagram illustrating an example of a menu screen to be displayed when the current time is within a predetermined time period after the operation of the electrical appliance is finished, and the electrical appliance is a washing machine;

FIG. 8A is a diagram illustrating an example of a menu screen to be displayed when the electrical appliance is in an error state, and the electrical appliance is a microwave oven;

FIG. 8B is a diagram illustrating an example of a menu screen to be displayed when the electrical appliance is in an error state, and the electrical appliance is a rice cooker;

FIG. 8C is a diagram illustrating an example of a menu screen to be displayed when the electrical appliance is in an error state, and the electrical appliance is a washing machine;

FIG. 8D is a diagram illustrating an example of a menu screen to be displayed when the electrical appliance is in an error state, and the electrical appliance is a microwave oven;

FIG. 9A is a diagram illustrating an example of a menu screen to be displayed when an electrical appliance is selected without performing proximity communication;

FIG. 9B is a diagram illustrating an example of a menu screen to be displayed when a microwave oven is selected in FIG. 9A;

FIG. 9C is a diagram illustrating an example of a menu screen to be displayed when a rice cooker is selected in FIG. 9A;

FIG. 9D is a diagram illustrating an example of a menu screen to be displayed when a washing machine is selected in FIG. 9A;

FIG. 10 is a diagram illustrating an entire configuration of a wireless communication system as a first modification of the embodiment of the invention;

FIG. 11 is a diagram illustrating an entire configuration of a wireless communication system as a second modification of the embodiment of the invention;

FIG. 12 is a diagram illustrating an entire configuration of a wireless communication system as a third modification of the embodiment of the invention;

FIG. 13 is a diagram illustrating an entire configuration of a wireless communication system as a fourth modification of the embodiment of the invention;

FIG. 14A is a diagram illustrating an example of a menu screen to be displayed when an information terminal is out of a predetermined range from home, and an electrical appliance is selected;

FIG. 14B is a diagram illustrating an example of a menu screen to be displayed when a microwave oven is selected in FIG. 14A;

FIG. 14C is a diagram illustrating an example of a menu screen to be displayed when a rice cooker is selected in FIG. 14A; and

FIG. 14D is a diagram illustrating an example of a menu screen to be displayed when a washing machine is selected in FIG. 14A.

### DETAILED DESCRIPTION OF THE PREFERRED EMBODIMENTS

An information terminal according to an aspect of the invention is an information terminal which displays a state of an appliance and controls an operation of the appliance. The information terminal is provided with a wireless communication unit which performs proximity communication with a proximity communication device provided in the appliance, and acquires menu creation information created in accordance with a state of the appliance; a menu creation unit which creates menu information relating to an operation of the appliance or relating to a service of the appliance, based on the menu creation information acquired by the wireless communication unit; and a display unit which displays the menu information created by the menu creation unit.

According to this configuration, menu information relating to an operation of the appliance or relating to a service of the appliance is created and displayed in accordance with a state of the appliance by proximity communication. This makes it easy for the user to operate the information terminal, and to enhance the user's operability.

In the information terminal, preferably, the menu creation unit may create menu information relating to a setting state of the appliance or relating to operation settings of the appliance when a state of the appliance represents that the appliance is in an inoperative state.

According to this configuration, when the appliance is in an inoperative state, menu information relating to a setting state of the appliance or relating to operation settings of the appliance is displayed. This makes it easy for the user to operate the information terminal, and to enhance the user's operability.

In the information terminal, preferably, the menu creation unit may create menu information relating to an operation state of the appliance or relating to an operation change of the appliance when a state of the appliance represents that the appliance is in an operated state.

According to this configuration, when the appliance is in an operated state, menu information relating to an operation state of the appliance or relating to an operation change of the appliance is displayed. This makes it easy for the user to operate the information terminal, and to enhance the user's operability.

In the information terminal, preferably, the menu creation unit may create menu information relating to an operation result of the appliance or relating to operation contents of the appliance when a state of the appliance represents that a current time is within a predetermined time period after the operation of the appliance is finished.

According to this configuration, when the current time is within a predetermined time period after the operation of the appliance is finished, menu information relating to an operation result of the appliance or relating to operation contents of the appliance is displayed. This makes it easy for the user to operate the information terminal, and to enhance the user's operability.

In the information terminal, preferably, the menu creation unit may create menu information relating to error contents of the appliance or relating to fault contents of the appliance when a state of the appliance represents that the appliance is in an error state or in a faulty state.

According to this configuration, when the appliance is in an error state or in a faulty state, menu information relating to error contents of the appliance or relating to fault contents of the appliance is displayed. This makes it easy for the user to operate the information terminal, and to enhance the user's operability.

In the information terminal, preferably, when the wireless communication unit performs proximity communication with the proximity communication device in a state that communication processing between the proximity communication device and the appliance is disabled, the menu creation unit may create menu information relating to a reason for the incapability of communication processing, in place of creating menu information relating to an operation of the appliance or relating to a service of the appliance.

According to this configuration, when communication processing between the appliance and the proximity communication device is disabled, menu information relating to an operation of the appliance or relating to a service of the appliance is not displayed. Thus, unusable menu information is not displayed. This makes it possible to enhance the user's operability. Further, menu information relating to a reason for the incapability of communication processing is displayed. This makes it possible to notify the user of a reason for the incapability of display or control, and a countermeasure.

In the information terminal, preferably, the wireless communication unit may perform communication with a position detection device which detects a position of the information terminal, and may acquire the position of the information terminal detected by the position detection device, the information terminal may be further provided with a position judgment unit which judges whether the position of the information terminal acquired by the wireless communication unit lies within a predetermined range with respect to a position of the proximity communication device, and the menu creation unit may create menu information in which a menu item requiring proximity communication with the proximity communication device is deleted, when the position judgment unit judges that the position of the information terminal is out of the predetermined range with respect to the position of the proximity communication device.

According to this configuration, it is possible to display menu information, in which a predetermined menu item is deleted in accordance with judgment as to whether proximity communication is enabled. This makes it easy for the user to operate the information terminal, and to enhance the user's operability.

An information display method according to another aspect of the invention is an information display method for displaying menu information relating to an operation of an appliance or relating to a service of the appliance. The information display method includes a step of detecting a state of the appliance; a step of creating menu creation information in accordance with a state of the appliance; a step of creating menu information based on the menu creation information; and a step of displaying the menu information.

According to this configuration, menu information relating to an operation of the appliance or relating to a service of the appliance is created and displayed in accordance with a state of the appliance by proximity communication. This makes it easy for the user to operate the information terminal, and to enhance the user's operability.

A control program according to yet another aspect of the invention is a control program for an information terminal which displays a state of an appliance and controls an operation of the appliance. The control program causes a computer to function as a wireless communication unit which performs proximity communication with a proximity communication device provided in the appliance, and acquires menu creation information created in accordance with a state of the appliance; a menu creation unit which creates menu information relating to an operation of the appliance or relating to a service of the appliance, based on the menu creation information acquired by the wireless communication unit; and a display unit which displays the menu information created by the menu creation unit.

According to this configuration, menu information relating to an operation of the appliance or relating to a service of the appliance is created and displayed in accordance with a state of the appliance by proximity communication. This makes it easy for the user to operate the information terminal, and to enhance the user's operability.

A server according to still another aspect of the invention is a server for communicating with an information terminal which displays a state of an appliance and controls an operation of the appliance. The server is provided with an acquisition unit which acquires menu creation information created in accordance with a state of the appliance from the appliance via the information terminal; a menu creation unit which creates menu information relating to an operation of the appliance or relating to a service of the appliance, based on the menu creation information acquired by the acquisition unit; and a transmitting unit which transmits the menu information created by the menu creation unit to the information terminal.

According to this configuration, menu information relating to an operation of the appliance or relating to a service of the appliance is created and displayed in accordance with a state of the appliance by proximity communication. This makes it easy for the user to operate the information terminal, and to enhance the user's operability.

In the following, an embodiment of the invention is described referring to the drawings. It should be noted that the invention is not limited by the following embodiment.

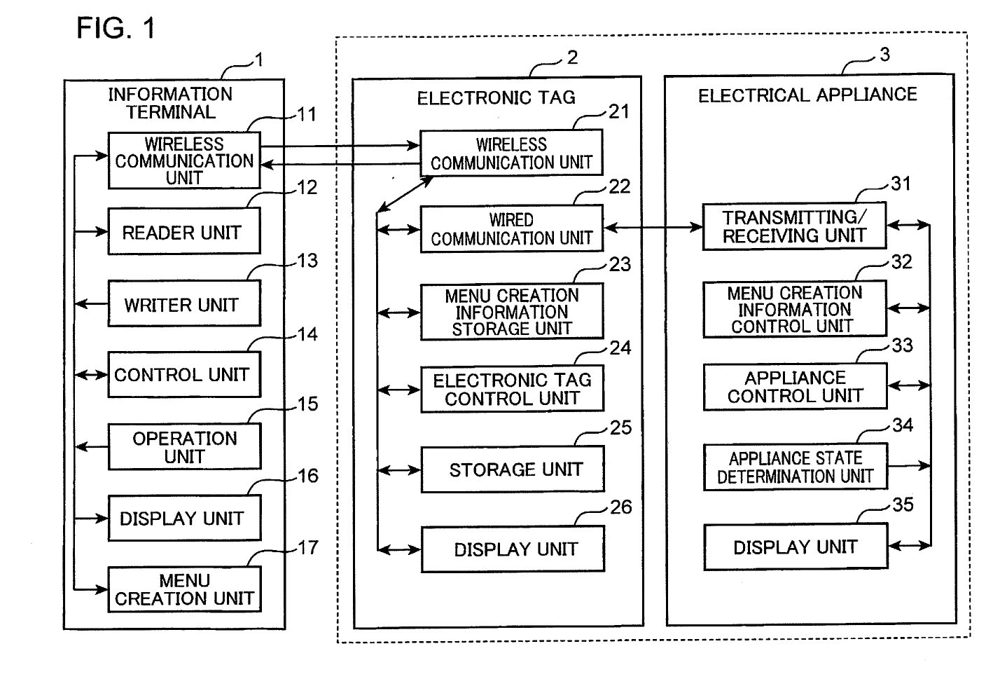

FIG. 1 is a diagram illustrating an entire configuration of a wireless communication system according to an embodiment of the invention.

The wireless communication system illustrated in FIG. 1 is provided with an information terminal as an electronic tag reader/writer, an electronic tag 2, and an electrical appliance 3. In the embodiment, proximity communication is non-contact communication with use of an electronic tag (the communication distance is about several centimeters). The invention is not limited to the above. Proximity communication may be communication whose communication distance is about several ten centimeters, such as Bluetooth (registered trademark). In the following, description is made based on the premise that an electronic tag is an example of a proximity communication device.

Communication whose communicable distance is short is free from a problem such that the user may erroneously select an electrical appliance with which the user wishes to communicate, even if the number of types of electrical appliances for communication increases. This reduces the number of confirmation screens to be displayed on the information terminal, and makes it easy for the user to operate the information terminal.

In particular, proximity communication is advantageous in that allowing the user to hold an information terminal to face an electrical appliance which the user wishes to directly operate (hold an information terminal at a position close to a portion of the main body housing of the electrical appliance where a mark indicating the position of an antenna of a built-in electronic tag is displayed) makes it possible to promptly display a menu relating to an operation or a service of the electrical appliance on the information terminal.

On the other hand, in the case where an information terminal and an electrical appliance are communicable with each other in a state that the information terminal and the electrical appliance are sufficiently away from each other, as exemplified by infrared communication and Wi-Fi communication, and a number of electrical appliances are present within a communicatable distance, it is necessary to provide a step of displaying, on the information terminal, that the electrical appliance for communication is an electrical appliance intended by the user for letting the user know the electrical appliance, before the menu relating to an operation or a service of the electrical appliance is displayed.

The information terminal 1 and the electronic tag 2 are connected to each other by proximity communication. For instance, the information terminal 1 is a mobile phone or a smartphone, and information is read from the electronic tag 2 or information is written in the electronic tag 2.

The electronic tag 2 and the electrical appliance 3 are connected to each other by wired communication. The electronic tag 2 may be integrally formed with the main body of the electrical appliance 3. Further, the electronic tag 2 may be built in a remote control device of the electrical appliance 3 or in an AC power adapter. Further, the electronic tag 2 may be constituted of an adapter, which is connectable to the electrical appliance 3, or is built in the electrical appliance 3, or is detachably attachable to the electrical appliance 3.

The information terminal 1 is provided with a wireless communication unit 11, a reader unit 12, a writer unit 13, a control unit 14, an operation unit 15, a display unit 16, and a menu creation unit 17.

The wireless communication unit 11 performs proximity communication with the electronic tag 2. For instance, the wireless communication unit 11 is a wireless communication module. The wireless communication unit 11 performs proximity communication with the electronic tag 2 provided in the electrical appliance 3, and acquires menu creation infounation created in accordance with a state of the electrical appliance 3.

The reader unit 12 reads the information written in a storage unit 25 of the electronic tag 2 via the wireless communication unit 11.

The writer unit 13 writes intended information in the storage unit 25 of the electronic tag 2 via the wireless communication unit 11.

The control unit 14 controls the wireless communication unit 11, the reader unit 12, and the writer unit 13 for wireless communication control, readout control from the electronic tag 2, and write-in control with respect to the electronic tag 2. Further, the control unit 14 controls the operation unit 15, the display unit 16, and the menu creation unit 17 to be described later for integrally controlling the main components of the information terminal 1.

The operation unit 15 accepts a user's instruction of information to be read with use of the reader unit 12 when the readout control is performed, and accepts a user's input of information to be written with use of the writer unit 13 when the write-in control is performed. Performing the above control makes it possible to acquire information of the electrical appliance 3, and to transmit control information.

The display unit 16 displays and notifies the information read from the electronic tag 2 when the readout control is performed, and displays and notifies the information input by the user when the write-in control is performed. Performing the above control makes it possible to notify the user of the information relating to the electrical appliance 3.

The menu creation unit 17 creates menu information relating to an operation of the electrical appliance 3 or relating to a service of the electrical appliance 3 to be displayed on the display unit 16 of the information terminal 1 in accordance with the menu creation information received from the electronic tag 2 via the wireless communication unit 11 and including a state of the electronic appliance 3, when the readout control or the write-in control is performed. The menu creation unit 17 creates menu information relating to an operation of the electrical appliance 3 or relating to a service of the electrical appliance 3, based on the menu creation information acquired by the wireless communication unit 11. The display unit 16 displays the menu information created by the menu creation unit 17. The details of the menu creation unit 17 will be described later.

The menu creation information is information for use in creating a menu (a list of operation items). The menu creation information may include a current state of the electrical appliance, a use history of the electrical appliance, or an error history of the electrical appliance in the past.

The wireless communication unit 11, the reader unit 12, and the writer unit 13 may be constituted of one module. Further, the operation unit 15, the display unit 16, and the menu creation unit 17 may be constituted of one module such as a touch panel.

As described above, the information terminal 1 performs wireless communication with the electronic tag 2, reads the information written in the storage unit 25 of the electronic tag 2, and writes intended information in the storage unit 25 of the electronic tag 2. As will be described later, the information terminal 1 controls the electrical appliance 3 wiredly connected to the electronic tag 2, and displays information relating to the electrical appliance 3.

The electronic tag 2 is provided with a wireless communication unit 21, a wired communication unit 22, a menu creation information storage unit 23, an electronic tag control unit 24, a storage unit 25, and a display unit 26.

The wireless communication unit 21 performs proximity communication with the information terminal 1. For instance, the wireless communication unit 21 is a wireless communication module.

The wired communication unit 22 communicates with the electrical appliance 3 by wired connection. For instance, the wired communication unit 22 is a wired communication module. The wired communication unit 22 receives the menu creation information transmitted from the electrical appliance 3.

The menu creation information storage unit 23 stores the menu creation information received by the wired communication unit 22.

The electronic tag control unit 24 controls the wireless communication unit 21 and the wired communication unit 22 to perform wireless communication control and wired communication control. Further, the electronic tag control unit 24 controls the menu creation information storage unit 23, the storage unit 25, and the display unit 26 to be described later for integrally controlling the main components of the electronic tag 2.

The storage unit 25 stores information to be stored in the electronic tag 2. The information stored in the storage unit 25 is read and written with respect to the information terminal 1 via the wireless communication unit 21. Further, the information stored in the storage unit 25 is read and written with respect to the electrical appliance 3 via the wired communication unit 22. The storage unit 25 may temporarily store (buffer) the communication information of the wireless communication unit 21 and of the wired communication unit 22.

The display unit 26 displays the information read from the storage unit 25, and notifies the user of the information under the control of the electronic tag 2. Further, the display unit 26 displays the information written in the storage unit 25 for notifying the user of the information relating to the electrical appliance 3.

The electronic tag 2 may not be provided with the display unit 26. A display unit 35 of the electrical appliance 3 to be described later may function as the display unit 26.

Further, the wireless communication unit 21, the wired communication unit 22, the menu creation information storage unit 23, the electronic tag control unit 24, and the storage unit 25 may be constituted of one module.

As described above, the electronic tag 2 performs communication with the information terminal 1 and with the electrical appliance 3, reads the information written in the storage unit 25, and writes information in the storage unit 25. As will be described later, the electronic tag 2 relays the information when the electrical appliance 3 is controlled by the information terminal 1, or when the information relating to a state of the electrical appliance 3 is displayed on the information terminal 1.

The electrical appliance 3 is provided with a transmitting/receiving unit 31, a menu creation information control unit 32, an appliance control unit 33, an appliance state determination unit 34, and the display unit 35.

The transmitting/receiving unit 31 communicates with the electronic tag 2 by wired connection, and acquires the information written in the storage unit 25 of the electronic tag 2. The information to be acquired by the transmitting/receiving unit 31 is setting information of the electrical appliance 3 or control information relating to an operation of the electrical appliance 3. Further, the information to be acquired by the transmitting/receiving unit 31 may be a request signal requesting information relating to a state of the electrical appliance 3, such as error information of the electrical appliance 3. The details of the information to be acquired by the transmitting/receiving unit 31 will be described later.

Further, the transmitting/receiving unit 31 communicates with the electronic tag 2 by wired connection, and writes information in the storage unit 25 of the electronic tag 2. The information to be written by the transmitting/receiving unit 31 includes setting information of the electrical appliance 3, result information representing a result of an operation of the electrical appliance 3, reply information with respect to a request from the information terminal 1, and log information to be transmitted to the information terminal 1 such as a use history of the electrical appliance 3.

The appliance control unit 33 controls the transmitting/receiving unit 31 to acquire information from the electronic tag 2, and to write information in the electronic tag 2. Further, the appliance control unit 33 controls the display unit 35 to be described later for integrally controlling the main components of the electrical appliance 3.

The appliance state determination unit 34 determines a state of the electrical appliance 3. The menu creation information control unit 32 writes menu creation information in the menu creation information storage unit 23 of the electronic tag 2, based on a determination result of the appliance state determination unit 34.

Specifically, the appliance state determination unit 34 communicates with the appliance control unit 33, acquires state information of the electrical appliance 3 periodically or each time the operation mode of the appliance control unit 33 is changed, accesses the electrical appliance 3 from the electronic tag 2, and determines whether the electrical appliance 3 is in a state capable of accepting setting information or control information relating to an operation. When the appliance state determination unit 34 determines that the electrical appliance 3 is inaccessible, the menu creation information control unit 32 creates menu creation information including menu creation disable information indicating that it is impossible to create menu information, and sets the created menu creation information in the menu creation information storage unit 23.

Further, when the appliance state determination unit 34 determines that the electrical appliance 3 is accessible from the electronic tag 2, and the electrical appliance 3 is capable of accepting setting information or control information relating to an operation, the menu creation information control unit 32 creates menu creation information including menu creation instruction information instructing creation of menu information, and sets the created menu creation information in the menu creation information storage unit 23.

The display unit 16 or the display unit 26 may notify that menu creation information including one of the menu creation disable information and the menu creation instruction information is set in the menu creation information storage unit 23.

Examples of the state that the electrical appliance 3 is inaccessible from the electronic tag 2 include a state in which the appliance control unit 33 is busy with processing and communication processing with the transmitting/receiving unit 31 is disabled, a state in which the operation mode of the appliance control unit 33 is a low electric consumption mode and communication processing with the transmitting/receiving unit 31 is disabled, a state in which electric power is not supplied to the electrical appliance 3, a state in which the power switch is in an off-state, a state in which the user performs operation settings with use of a switch on the main body of the electrical appliance 3, and a state in which a result of performing operation settings by the user is displayed on the main body of the electrical appliance 3.

Further, examples of the state that the electrical appliance 3 is accessible from the electronic tag 2, and the electrical appliance 3 is capable of accepting setting information or control information relating to an operation include a state in which the electrical appliance 3 is in a standby state for settings, a state in which the electrical appliance 3 is under operation, a state in which the current time is within a predetermined time period after the operation of the electrical appliance 3 is finished, an error state in which an error has occurred in the electrical appliance 3, and a faulty state that the electrical appliance 3 has a trouble.

The display unit 35 displays information acquired from the menu creation information storage unit 23 of the electronic tag 2, or information written in the menu creation information storage unit 23 of the electronic tag 2 under the control of the electrical appliance 3. Further, the display unit 35 displays the information of the electrical appliance 3 for notifying the user of the information relating to the electrical appliance 3 or relating to the electronic tag 2.

The transmitting/receiving unit 31, the menu creation information control unit 32, the appliance control unit 33, and the appliance state determination unit 34 may be constituted of one module.

As described above, the electrical appliance 3 performs communication with the electronic tag 2, acquires information written in the storage unit 25 of the electronic tag 2, and writes information in the storage unit 25 of the electronic tag 2. Thus, the electrical appliance 3 is controlled by the information terminal 1 via the electronic tag 2, and information relating to a state of the electrical appliance 3 is displayed on the information terminal 1.

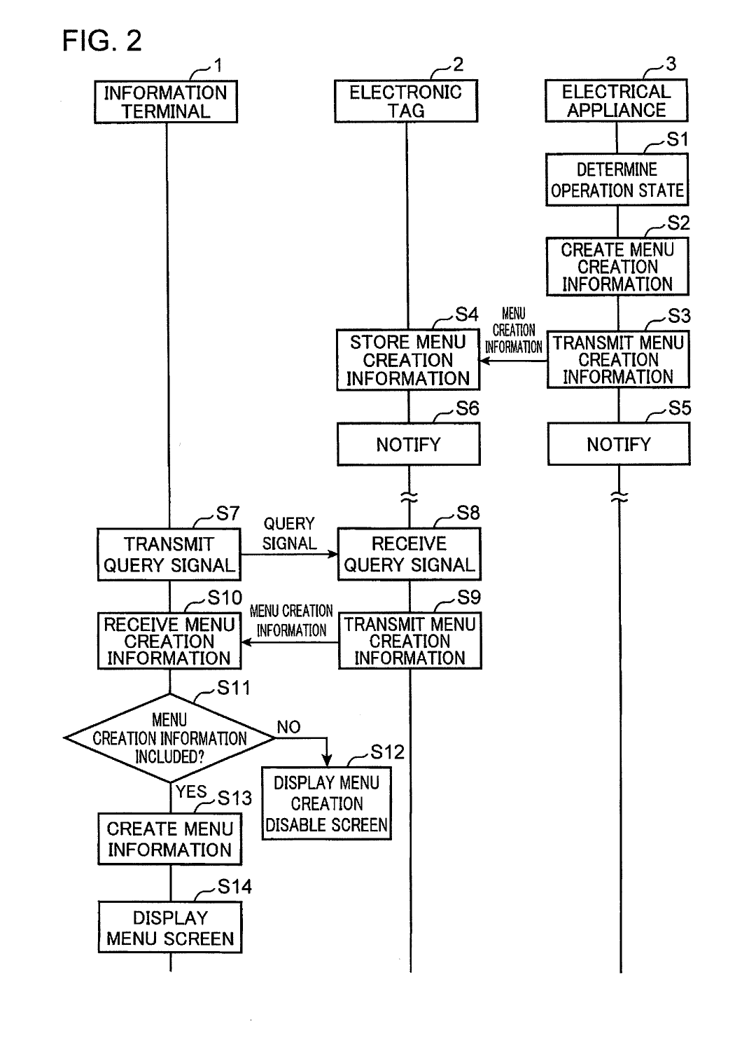

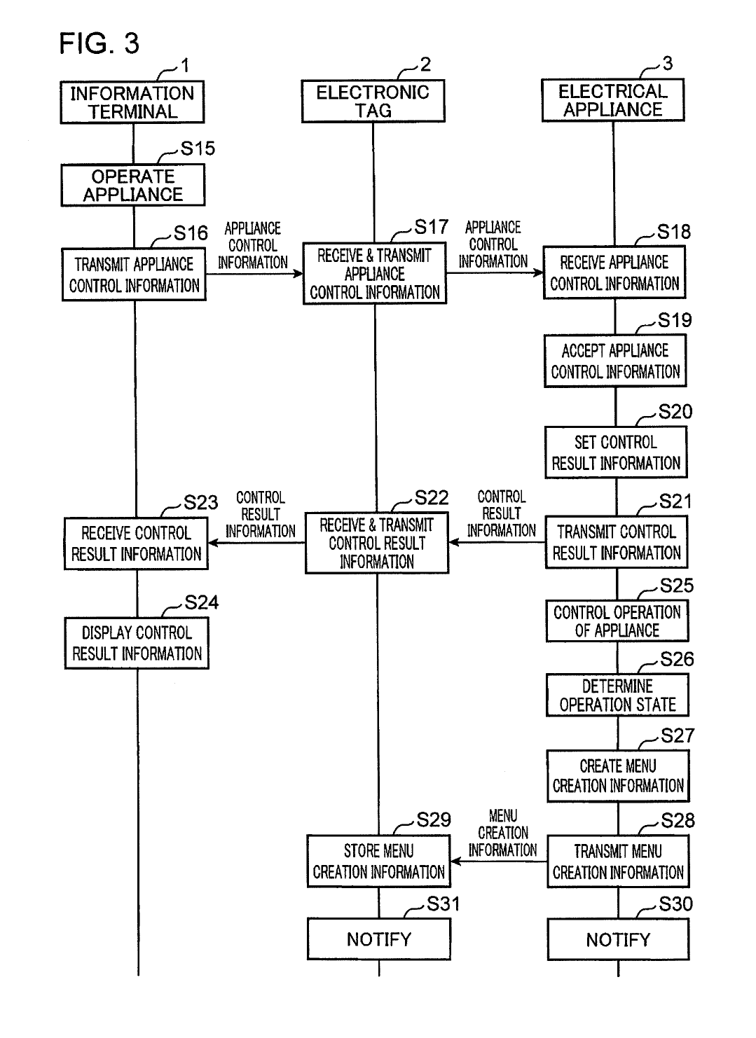

An operation example of the information terminal 1, the electronic tag 2, and the electrical appliance 3 as described above is described referring to FIG. 2 and FIG. 3.

FIG. 2 is a first sequence diagram for describing an operation to be performed by the wireless communication system of the embodiment. FIG. 3 is a second sequence diagram for describing the operation to be performed by the wireless communication system of the embodiment.

In Step S1, the appliance state determination unit 34 determines an operation state of the electrical appliance 3. The appliance state determination unit 34 determines whether the operation state of the electrical appliance 3 is an operation state that information is accepted from the electronic tag 2.

When the operation state of the electrical appliance 3 is an operation state that information is accepted from the electronic tag 2, in Step S2, the menu creation information control unit 32 creates menu creation information including menu creation instruction information.

Further, when the operation state of the electrical appliance 3 is an operation state that information is not accepted from the electronic tag 2 (communication processing is disabled), in Step S2, the menu creation information control unit 32 creates menu creation information including menu creation disable information.

In Step S3, the transmitting/receiving unit 31 transmits the menu creation information created by the menu creation information control unit 32 to the electronic tag 2.

As described above, the menu creation information includes menu creation disable information or menu creation instruction information.

In the embodiment, the menu creation instruction information includes the following four menu creation instruction information items.

The first menu creation instruction information item represents that the electrical appliance 3 is in a standby state for operation settings. The second menu creation instruction information item represents that the electrical appliance 3 is under operation. The third menu creation instruction information item represents that the electrical appliance 3 is in a state after the operation of the electrical appliance 3 is finished (in a state that the current time is within a predetermined time period after the operation of the electrical appliance 3 is finished). The fourth menu creation instruction information item represents that the electrical appliance 3 is in an error state or in a faulty state.

Further, in the embodiment, the menu creation disable information includes the following four menu creation disable information items.

The first menu creation disable information item represents that the power plug of the electrical appliance 3 is not inserted in the power receptacle. The second menu creation disable information item represents that the power switch of the electrical appliance 3 is not in an on-state. The third menu creation disable information item represents that the main body of the electrical appliance 3 is under operation. The fourth menu creation disable information item represents that the electrical appliance 3 is in a state that the operation thereof is reserved.

Subsequently, in Step S4, the wired communication unit 22 of the electronic tag 2 receives the menu creation information transmitted from the electrical appliance 3, and stores the received menu creation information in the menu creation information storage unit 23.

Subsequently, in Step S5, the display unit 35 of the electrical appliance 3 displays that the menu creation information is one of the first to fourth menu creation instruction information items and the first to fourth menu creation disable information items, and notifies the user of the information.

Subsequently, in Step S6, the display unit 26 of the electronic tag 2 displays that the menu creation information is one of the first to fourth menu creation instruction information items and the first to fourth menu creation disable information items, and notifies the user of the information. As described above, one of the display unit 35 of the electrical appliance 3 and the display unit 26 of the electronic tag 2 may be operative to display that the menu creation information is one of the first to fourth menu creation instruction information items and the first to fourth menu creation disable information items. Further alternatively, both of the display unit 35 of the electrical appliance 3 and the display unit 26 of the electronic tag 2 may be inoperative to display that the menu creation information is one of the first to fourth menu creation instruction information items and the first to fourth menu creation disable information items.

Performing non-contact communication between the electronic tag 2 and the information terminal 1 as proximity communication makes it possible for the electronic tag 2 to communicate with the information terminal 1 even in a state that electric power is not supplied to the electronic tag 2. Further, even when electric power is supplied to the electronic tag 2 and to the electrical appliance 3 from one power source, it is possible to include the first menu creation disable information item and the second menu creation disable information item relating to a state of the power source in the menu creation disable information.

Next, the wireless communication unit 11 of the information terminal 1 performs wireless communication with the wireless communication unit 21 of the electronic tag 2. When the user checks the state of the electrical appliance 3, or when the user operates the electrical appliance 3, the user holds the information terminal 1 close to the electronic tag 2.

When the information terminal 1 is held close to the electronic tag 2 (or when the electronic tag 2 is held close to the information terminal 1), the information terminal 1 starts non-contact communication with the electronic tag 2. In Step S7, the wireless communication unit 11 of the information terminal 1 transmits, to the electronic tag 2, a query signal requesting transmission of menu creation information.

Subsequently, in Step S8, the wireless communication unit 21 of the electronic tag 2 receives the query signal transmitted from the information terminal 1.

Subsequently, in Step S9, the wireless communication unit 21 of the electronic tag 2 reads the menu creation information stored in the menu creation information storage unit 23, and transmits the read menu creation information to the information terminal 1.

Subsequently, in Step S10, the wireless communication unit 11 of the information terminal 1 receives the menu creation information transmitted form the electronic tag 2.

The processing of Step S7 to Step S10 corresponds to a one-time non-contact communication operation of holding the information terminal 1 close to the electronic tag 2.

Subsequently, in Step S11, the menu creation unit 17 determines whether the received menu creation information includes one of the menu creation instruction information and the menu creation disable information. In this example, when it is determined that the menu creation information does not include the menu creation instruction information, in other words, when it is determined that the menu creation information includes the menu creation disable information (NO in Step S11), in Step S12, the display unit 16 of the information terminal 1 displays a menu creation disable screen representing that it is impossible to display a menu screen, and notifies the user of the incapability of displaying a menu screen.

When the menu creation information includes menu creation disable information, it is impossible to communicate state information or control information of the electrical appliance 3 between the electronic tag 2 and the electrical appliance 3. Therefore, it is impossible for the information terminal 1 to request the electronic tag 2 of state information of the electrical appliance 3, and it is impossible to transmit control information of the electrical appliance 3 to the electronic tag 2.

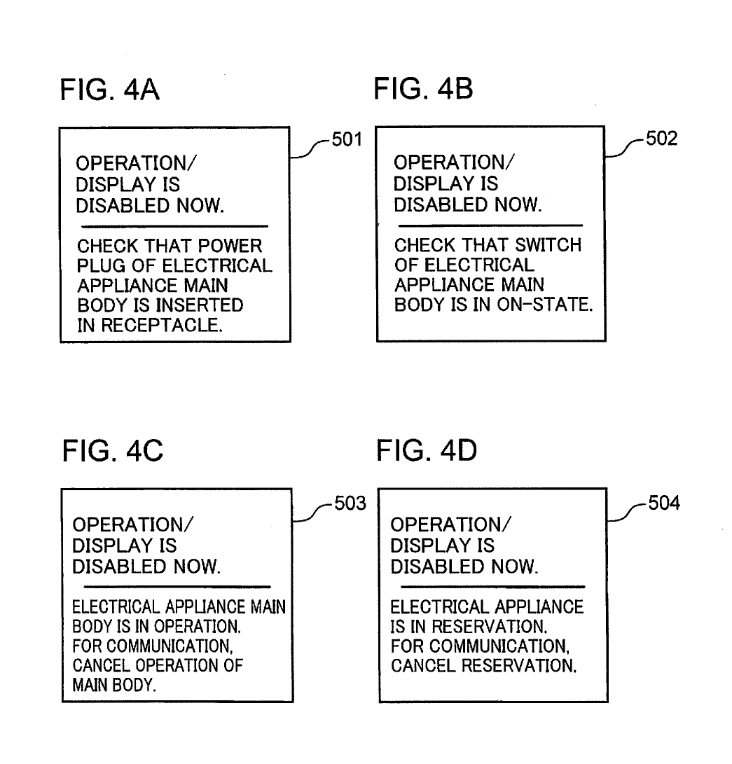

In view of the above, the menu creation unit 17 creates a menu creation disable screen representing that display and operation of the electrical appliance 3 are disabled, a reason for the incapability, and a countermeasure in accordance with the first to fourth menu creation disable information items. The display unit 16 of the information terminal 1 displays the menu creation disable screen. An example of the menu creation disable screen to be displayed on the information terminal 1 is illustrated in FIGS. 4A to 4D.

FIG. 4A is a diagram illustrating an example of a menu creation disable screen to be displayed when the power plug of the electrical appliance 3 is not inserted in the power receptacle. FIG. 4B is a diagram illustrating an example of a menu creation disable screen to be displayed when the power switch of the electrical appliance 3 is not in an on-state. FIG. 4C is a diagram illustrating an example of a menu creation disable screen to be displayed when the electrical appliance 3 is in operation by the user. FIG. 4D is a diagram illustrating an example of a menu creation disable screen to be displayed when the electrical appliance 3 is in a standby state that the operation thereof is reserved.

As illustrated in FIG. 4A, when the power plug of the electrical appliance 3 is not inserted in the power receptacle, an indication indicating that display and operation of the electrical appliance 3 are disabled is displayed on a menu creation disable screen 501. For instance, a text “OPERATION/DISPLAY IS DISABLED NOW” is displayed on the menu creation disable screen 501. Further, a reason for the incapability and a countermeasure are also displayed on the menu creation disable screen 501. For instance, a text “CHECK THAT POWER PLUG OF ELECTRICAL APPLIANCE MAIN BODY IS INSERTED IN RECEPTACLE” is displayed on the menu creation disable screen 501.

Further, as illustrated in FIG. 4B, when the power switch of the electrical appliance 3 is not in an on-state, an indication indicating that display and operation of the electrical appliance 3 are disabled is displayed on a menu creation disable screen 502. For instance, a text “OPERATION/DISPLAY IS DISABLED NOW” is displayed on the menu creation disable screen 502. Further, a reason for the incapability and a countermeasure are displayed on the menu creation disable screen 502. For instance, a text “CHECK THAT SWITCH OF ELECTRICAL APPLIANCE MAIN BODY IS IN ON-STATE” is displayed on the menu creation disable screen 502.

Further, as illustrated in FIG. 4C, when the electrical appliance 3 is in operation by the user, an indication indicating that display and operation of the electrical appliance 3 are disabled is displayed on a menu creation disable screen 503. For instance, a text “OPERATION/DISPLAY IS DISABLED NOW” is displayed on the menu creation disable screen 503. Further, a reason for the incapability and a countermeasure are displayed on the menu creation disable screen 503. For instance, a text “ELECTRICAL APPLIANCE MAIN BODY IS OPERATED. FOR COMMUNICATION, CANCEL OPERATION OF MAIN BODY” is displayed on the menu creation disable screen 503.

Further, as illustrated in FIG. 4D, when the electrical appliance 3 is in a state that the operation thereof is reserved, an indication indicating that display and operation of the electrical appliance 3 are disabled is displayed on a menu creation disable screen 504. For instance, a text “OPERATION/DISPLAY IS DISABLED NOW” is displayed on the menu creation disable screen 504. Further, a reason for the incapability and a countermeasure are displayed on the menu creation disable screen 504. For instance, a text “ELECTRICAL APPLICATION IS IN RESERVATION. FOR COMMUNICATION, CANCEL RESERVATION” is displayed on the menu creation disable screen 504.

As described above, when proximity communication of the wireless communication unit 11 with the electronic tag 2 is performed in a state that communication processing between the electronic tag 2 and the electrical appliance 3 is disabled, the menu creation unit 17 creates menu information relating to a reason for the incapability of communication processing, in place of creating menu information relating to an operation of the electrical appliance 3 or relating to a service of the electrical appliance 3.

On the other hand, referring back to FIG. 2, when it is determined that menu creation information includes menu creation instruction information (YES in Step S11), in Step S13, the menu creation unit 17 creates a menu screen (menu information) relating to indications, settings, and controllable contents in accordance with the menu creation instruction information.

Subsequently, in Step S14, the display unit 16 displays a menu screen created by the menu creation unit 17.

The menu information is information for constituting a menu screen, and may include information relating to menu layers, in addition to the names of items to be displayed on the menu screen.

The menu creation unit 17 creates a menu screen (menu information) which is displayable or controllable with respect to the electrical appliance 3 in accordance with the first to fourth menu creation instruction information items. The display unit 16 of the information terminal 1 displays a menu screen created by the menu creation unit 17. An example of a menu screen to be displayed on the information terminal 1 is described with respect to each of the first to fourth menu creation instruction information items.

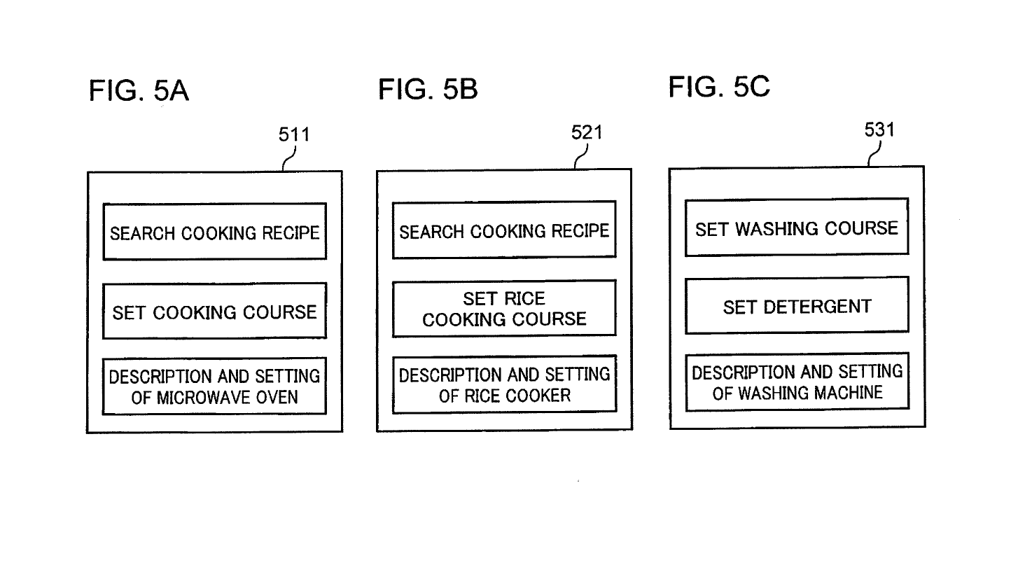

FIGS. 5A to 5C are diagrams illustrating menu screens to be displayed on the display unit 16 of the information terminal 1, in the case where the information terminal 1 performs non-contact communication with the electronic tag 2 in proximity thereto when the power switch of the electrical appliance 3 is in an on-state, and the electrical appliance 3 is in a standby state for operation settings in accordance with the first menu creation instruction information item, in other words, when the electrical appliance 3 is in an inoperative state.

FIG. 5A is a diagram illustrating an example of a menu screen to be displayed when the electrical appliance 3 is in a standby state for operation settings, and the electrical appliance 3 is a microwave oven. FIG. 5B is a diagram illustrating an example of a menu screen to be displayed when the electrical appliance 3 is in a standby state for operation settings, and the electrical appliance 3 is a rice cooker. FIG. 5C is a diagram illustrating an example of a menu screen to be displayed when the electrical appliance 3 is in a standby state for operation settings, and the electrical appliance 3 is a washing machine. When the electrical appliance 3 is in an inoperative state, there are displayed a menu for allowing the user to search or set an operation course available for the electrical appliance 3, a menu for allowing the user to set the main body of the electrical appliance or to perform the initial setting, and a menu for explaining about the electrical appliance.

As illustrated in FIG. 5A, when the electrical appliance 3 is in a standby state for operation settings, and the electrical appliance 3 is a microwave oven, for instance, three operation items “SEARCH COOKING RECIPE”, “SET COOKING COURSE”, and “DESCRIPTION AND SETTING OF MICROWAVE OVEN” are displayed on a menu screen 511. When the item “SEARCH COOKING RECIPE” is selected, cooking recipes with use of the microwave oven are displayed. When the item “SET COOKING RECIPE” is selected, a setting screen for allowing the user to set an output electric power, a heating temperature, and a heating time is displayed. When the item “DESCRIPTION AND SETTING OF MICROWAVE OVEN” is selected, an operation manual of the microwave oven is displayed.

As illustrated in FIG. 5B, when the electrical appliance 3 is in an standby state for operation settings, and the electrical appliance 3 is a rice cooker, for instance, three operation items “SEARCH COOKING RECIPE”, “SET RICE COOKING COURSE”, and “DESCRIPTION AND SETTING OF RICE COOKER” are displayed on a menu screen 521. When “SEARCH COOKING RECIPE” is selected, the cooking recipes with use of the rice cooker are displayed. When “SET RICE COOKING COURSE” is selected, a setting screen for allowing the user to set a type of rice and a rice cooking mode is displayed. When “DESCRIPTION AND SETTING OF RICE COOKER” is selected, an operation manual of the rice cooker is displayed.

As illustrated in FIG. 5C, when the electrical appliance 3 is in a standby state for operation settings, and the electrical appliance 3 is a washing machine, for instance, three operation items “SET WASHING COURSE”, “SELECT DETERGENT”, and “DESCRIPTION AND SETTING OF WASHING MACHINE” are displayed on a menu screen 531. When “SET WASHING COURSE” is selected, a setting screen for setting a washing mode is displayed. When “SELECT DETERGENT” is selected, a setting screen for setting a type of detergent is displayed. “DESCRIPTION AND SETTING OF WASHING MACHINE” is selected, an operation manual of the washing machine is displayed.

In this way, the menu creation unit 17 creates menu information relating to a setting state of the electrical appliance 3 or relating to operation settings of the electrical appliance 3 when the state of the electrical appliance 3 represents an inoperative state of the electrical appliance 3.

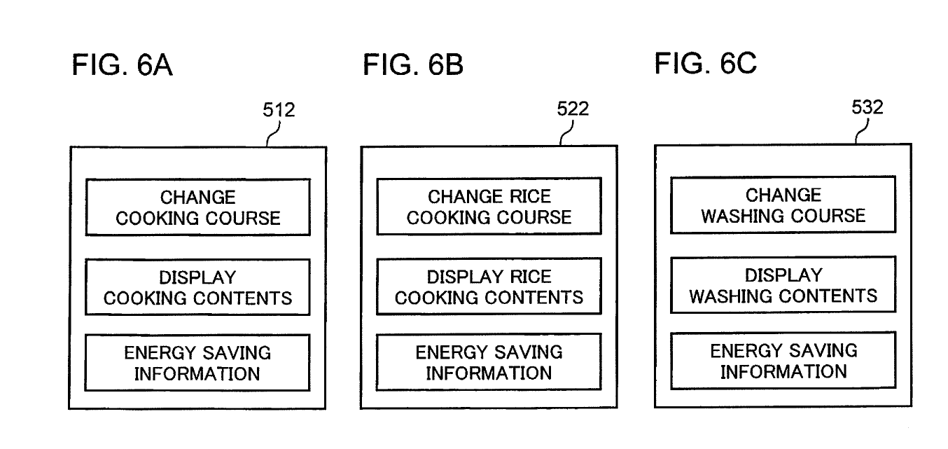

FIGS. 6A to 6C are diagrams illustrating menu screens to be displayed on the display unit 16 of the information terminal 1, in the case where the information terminal 1 performs non-contact communication with the electronic tag 2 in proximity thereto when the electrical appliance 3 is under operation in accordance with the second menu creation instruction information item.

FIG. 6A is a diagram illustrating an example of a menu screen to be displayed when the electrical appliance 3 is under operation, and the electrical appliance 3 is a microwave oven. FIG. 6B is a diagram illustrating an example of a menu screen to be displayed, when the electrical appliance 3 is under operation, and the electrical appliance 3 is a rice cooker. FIG. 6C is a diagram illustrating an example of a menu screen to be displayed, when the electrical appliance 3 is under operation, and the electrical appliance 3 is a washing machine. In this case, the electrical appliance 3 is under operation. Therefore, unlike the configuration illustrated in FIGS. 5A to 5C, there are displayed a menu for allowing the user to change the operation contents of the electrical appliance under operation, a menu for displaying a current operation state (e.g. the mode under operation), and a menu for displaying energy saving setting or an energy saving degree of the current operation contents.

As illustrated in FIG. 6A, when the electrical appliance 3 is under operation, and the electrical appliance 3 is a microwave oven, for instance, three items “CHANGE COOKING COURSE”, “DISPLAY COOKING CONTENTS”, and “ENERGY SAVING INFORMATION” are displayed on a menu screen 512. When the item “CHANGE COOKING COURSE” is selected, a setting screen for allowing the user to change the current cooking course is displayed. When the item “DISPLAY COOKING CONTENTS” is selected, a screen representing a current operation state of the microwave oven is displayed. When “ENERGY SAVING INFORMATION” is selected, a screen representing energy saving setting or an energy saving degree of the current operation contents of the microwave oven is displayed.

As illustrated in FIG. 6B, when the electrical appliance 3 is under operation, and the electrical appliance 3 is a rice cooker, for instance, three operation items “CHANGE RICE COOKING COURSE”, “DISPLAY RICE COOKING CONTENTS”, and “ENERGY SAVING INFORMATION” are displayed on a menu screen 522. When the item “CHANGE RICE COOKING COURSE” is selected, a setting screen for allowing the user to change the current rice cooking course is displayed. When the item “DISPLAY RICE COOKING CONTENTS” is selected, a screen representing a current operation state of the rice cooker is displayed. When “ENERGY SAVING INFORMATION” is selected, a screen representing energy saving setting or an energy saving degree of the current operation contents of the rice cooker is displayed.

As illustrated in FIG. 6C, when the electrical appliance 3 is under operation, and the electrical appliance 3 is a washing machine, for instance, three operation items “CHANGE WASHING COURSE”, “DISPLAY WASHING CONTENTS”, and “ENERGY SAVING INFORMATION” are displayed on a menu screen 532. When the item “CHANGE WASHING COURSE” is selected, a setting screen for allowing the user to change the current washing course is displayed. When the item “DISPLAY WASHING CONTENTS” is selected, a screen representing a current operation state of the washing machine is displayed. When “ENERGY SAVING INFORMATION” is selected, a screen representing energy saving setting or an energy saving degree of the current operation contents of the washing machine is displayed.

In this way, the menu creation unit 17 creates menu information relating to an operation state of the electrical appliance 3 or relating to an operation change of the electrical appliance 3, when the state of the electrical appliance 3 represents a state that the electrical appliance 3 is under operation.

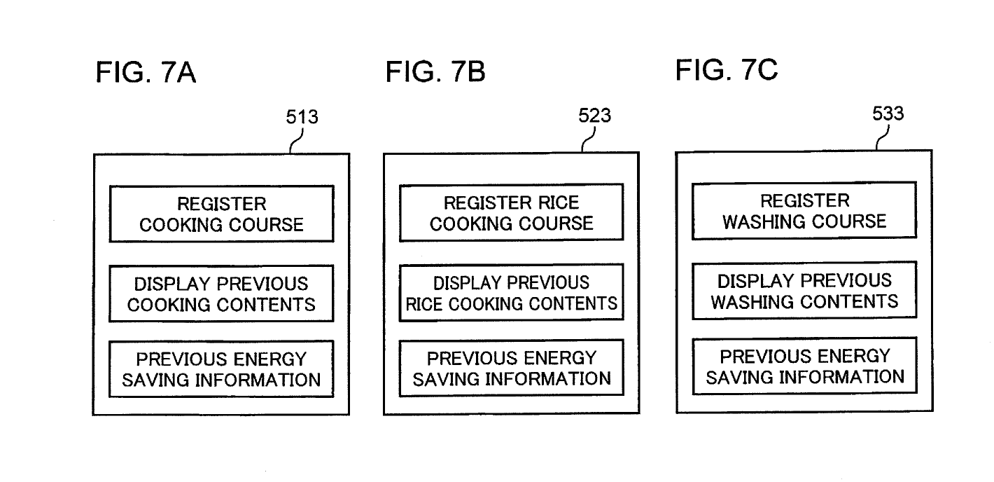

FIGS. 7A to 7C are diagrams illustrating menu screens to be displayed on the display unit 16 of the information terminal 1, in the case where the information terminal 1 performs non-contact communication with the electronic tag 2 in proximity thereto, when the current time is within a predetermined time period after the operation of the electrical appliance 3 is finished in accordance with the third menu creation instruction information item. The predetermined time period is measured by timer means (not illustrated), and is 10 minutes, for instance. Further, the predetermined time period may be a time period during which a temperature in the inside of the electrical appliance 3 or a temperature measured by a temperature sensor (not illustrated) of heating means is not lower than a predetermined value.

FIG. 7A is a diagram illustrating an example of a menu screen to be displayed when the current time is within a predetermined time period after the operation of the electrical appliance 3 is finished, and the electrical appliance 3 is a microwave oven. FIG. 7B is a diagram illustrating an example of a menu screen to be displayed when the current time is within a predetermined time period after the operation of the electrical appliance 3 is finished, and the electrical appliance 3 is a rice cooker. FIG. 7C is a diagram illustrating an example of a menu screen to be displayed when the current time is within a predetermined time period after the operation of the electrical appliance 3 is finished, and the electrical appliance 3 is a washing machine. In this case, the electrical appliance 3 is in a state immediately after the operation thereof is finished. Therefore, unlike the configurations illustrated in FIGS. 5A to 5C, and FIGS. 6A to 6C, there are displayed a menu for allowing the user to register the operated contents and to call the contents easily next time, a menu for displaying the finished operation contents (e.g. contents of the operation course or the operation time), and a menu for displaying energy saving information of a current operation (e.g. an electricity cost or used electric energy).

As illustrated in FIG. 7A, when the current time is within a predetermined time period after the operation of the electrical appliance 3 is finished, and the electrical appliance 3 is a microwave oven, for instance, three operation items “REGISTER COOKING COURSE”, “DISPLAY PREVIOUS COOKING CONTENTS”, and “PREVIOUS ENERGY SAVING INFORMATION” are displayed on a menu screen 513. When the item “REGISTER COOKING COURSE” is selected, a setting screen for registering the previous cooking course is displayed. When the item “DISPLAY PREVIOUS COOKING CONTENTS” is selected, a screen representing a previous operation state of the microwave oven is displayed. When “PREVIOUS ENERGY SAVING INFORMATION” is selected, a screen representing energy saving setting or an energy saving degree of the previous operation contents of the microwave oven is displayed.

As illustrated in FIG. 7B, when the current time is within a predetermined time period after the operation of the electrical appliance 3 is finished, and the electrical appliance 3 is a rice cooker, for instance, three operation items “REGISTER RICE COOKING COURSE”, “DISPLAY PREVIOUS RICE COOKING CONTENTS”, and “PREVIOUS ENERGY SAVING INFORMATION” are displayed on a menu screen 523. When the item “REGISTER RICE COOKING COURSE” is selected, a setting screen for allowing the user to register the previous rice cooking course is displayed. When the item “DISPLAY PREVIOUS RICE COOKING CONTENTS” is selected, a screen representing the previous operation state of the rice cooker is displayed. When “PREVIOUS ENERGY SAVING INFORMATION” is selected, a screen representing energy saving setting or an energy saving degree of the previous operation contents of the rice cooker is displayed.

As illustrated in FIG. 7C, when the current time is within a predetermined time period after the operation of the electrical appliance 3 is finished, and the electrical appliance 3 is a washing machine, for instance, three operation items “REGISTER WASHING COURSE”, “DISPLAY PREVIOUS WASHING CONTENTS”, and “PREVIOUS ENERGY SAVING INFORMATION” are displayed on a menu screen 533. When the item “REGISTER WASHING COURSE” is selected, a setting screen for allowing the user to register the previous washing course is displayed. When the item “DISPLAY PREVIOUS WASHING CONTENTS” is selected, a screen representing the previous operation state of the washing machine is displayed. When “PREVIOUS ENERGY SAVING INFORMATION” is selected, a screen representing energy saving setting or an energy saving degree of the previous operation contents of the washing machine is displayed.

In this way, the menu creation unit 17 creates menu information relating to an operation result of the electrical appliance 3 or relating to operation contents of the electrical appliance 3 when the state of the electrical appliance 3 represents that the current time is within a predetermined time period after the operation of the electrical appliance 3 is finished.

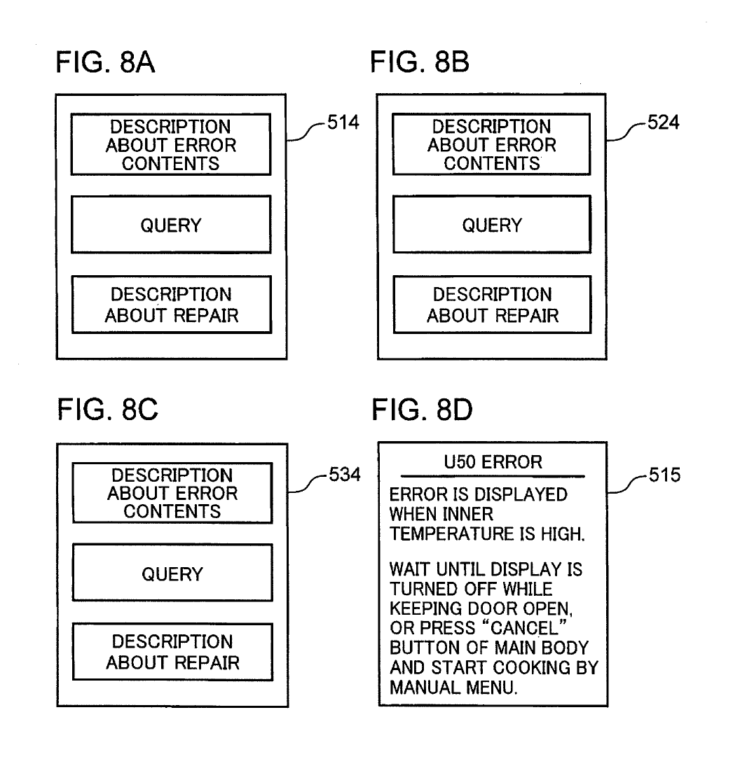

FIGS. 8A to 8D are diagrams illustrating menu screens to be displayed on the display unit 16 of the information terminal 1, in the case where the information terminal 1 performs non-contact communication with the electronic tag 2 in proximity thereto, when the electrical appliance 3 is in an error state or in a faulty state in accordance with the fourth menu creation instruction information item.

FIG. 8A is a diagram illustrating an example of a menu screen to be displayed when the electrical appliance 3 is in an error state, and the electrical appliance 3 is a microwave oven. FIG. 8B is a diagram illustrating an example of a menu screen to be displayed when the electrical appliance 3 is in an error state, and the electrical appliance 3 is a rice cooker. FIG. 8C is a diagram illustrating an example of a menu screen to be displayed when the electrical appliance 3 is in an error state, and the electrical appliance 3 is a washing machine. FIG. 8D is a diagram illustrating an example of a screen to be displayed when the electrical appliance 3 is in an error state, and the electrical appliance 3 is a microwave oven.

In this case, the electrical appliance 3 is in an error state or in an faulty state. Therefore, unlike the configurations illustrated in FIGS. 5A to 5C, FIGS. 6A to 6C, and FIGS. 7A to 7C, as illustrated in FIGS. 8A to 8C, there are displayed a menu describing error contents, a menu describing a query method to the manufacturer of the electrical appliance 3, and a menu describing repair such as acceptance of repair. Further, as illustrated in FIG. 8D, not a menu but a screen for notifying the user of an error or a cause of a fault may be displayed depending on the menu creation instruction information. Further, there may be displayed a menu for allowing the user to create an electronic mail querying to the manufacturer of the electrical appliance 3, and a menu for linking to a service for electronically performing the procedures on acceptance of repair via the Internet.

As illustrated in FIG. 8A, when the electrical appliance 3 is in an error state, and the electrical appliance 3 is a microwave oven, for instance, three operation items “DESCRIPTION ABOUT ERROR CONTENTS”, “QUERY”, and “DESCRIPTION ABOUT REPAIR” are displayed on a menu screen 514. When the item “DESCRIPTION ABOUT ERROR CONTENTS” is selected, a setting screen for describing the generated error contents is displayed. When the item “QUERY” is selected, a screen representing a method for querying to the manufacturer of the electrical appliance 3 is displayed. When “DESCRIPTION ABOUT REPAIR” is selected, a screen for describing repair such as acceptance of repair is displayed.

As illustrated in FIG. 8B, when the electrical appliance 3 is in an error state, and the electrical appliance 3 is a rice cooker, for instance, three operation items “DESCRIPTION ABOUT ERROR CONTENTS”, “QUERY”, and “DESCRIPTION ABOUT REPAIR” are displayed on a menu screen 524.

As illustrated in FIG. 8C, when the electrical appliance 3 is in an error state, and the electrical appliance 3 is a washing machine, for instance, three operation items “DESCRIPTION ABOUT ERROR CONTENTS”, “QUERY”, and “DESCRIPTION ABOUT REPAIR” are displayed on a menu screen 534.

Further, as illustrated in FIG. 8D, when the electrical appliance 3 is in an error state, and the electrical appliance 3 is a microwave oven, for instance, it is possible to display a text describing the error contents, and describing a countermeasure against the error on a menu screen 515.

In this way, the menu creation unit 17 creates menu information relating to error contents of the electrical appliance 3 or relating to fault contents of the electrical appliance 3, when the state of the electrical appliance 3 represents an error state or a faulty state of the electrical appliance 3.

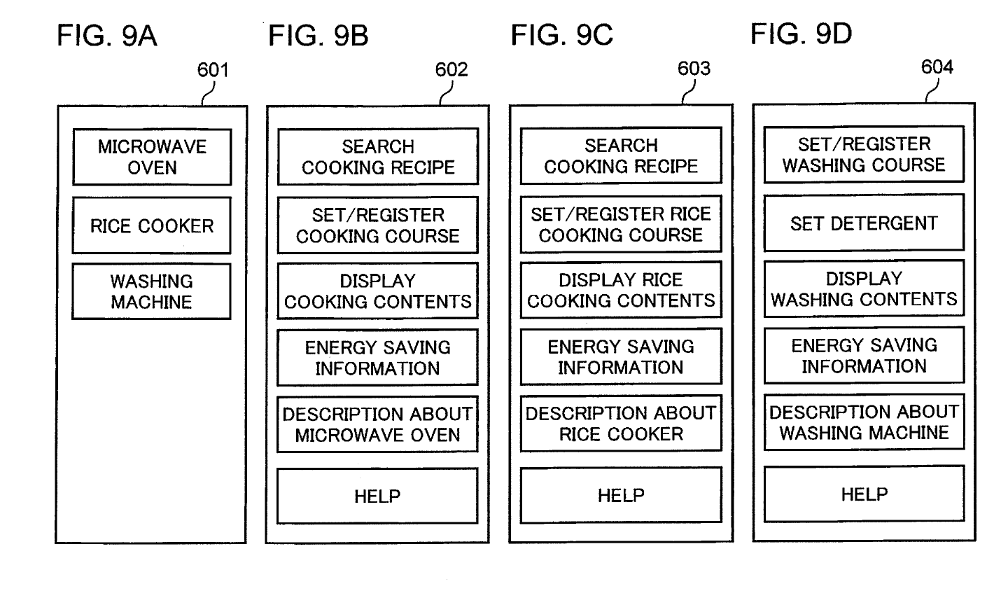

FIGS. 9A to 9D are diagrams illustrating menu screens to be displayed on the display unit 16 of the information terminal 1, when the operation unit 15 of the information terminal 1 is operated, and a menu screen is displayed, without performing non-contact communication of the information terminal 1 with the electronic tag 2 in proximity thereto. The menu creation unit 17 creates menu information in response to a user's operation accepted on the operation unit 15, when proximity communication with the electronic tag 2 is not performed.

FIG. 9A is a diagram illustrating an example of a menu screen to be displayed when an electrical appliance is selected without performing proximity communication. FIG. 9B is a diagram illustrating an example of a menu screen to be displayed when a microwave oven is selected in FIG. 9A. FIG. 9C is a diagram illustrating an example of a menu screen to be displayed when a rice cooker is selected in FIG. 9A. FIG. 9D is a diagram illustrating an example of a menu screen to be displayed when a washing machine is selected in FIG. 9A.

First of all, menu information on a top menu screen 601 as illustrated in FIG. 9A is created and displayed so that the user is allowed to select an electrical appliance to be operated. Then, menu information relating to the electrical appliance 3 selected by the user with use of the operation unit 15 is created, and menu screens 602 to 604 are displayed. In this case, proximity communication is not performed with the electronic tag 2. Therefore, an operation state of the electrical appliance 3 is unknown. In view of the above, all the possible operation states are assumed, and all the menu contents illustrated in FIGS. 5A to 5C, FIGS. 6A to 6C, FIGS. 7A to 7C, and FIGS. 8A to 8C are displayed. It should be noted that there are unillustrated menus to be displayed on a lower layer of the menus illustrated in FIGS. 9B to 9D depending on the menu.

Display of a menu screen or control by a menu screen may be disabled, in the case where a menu screen as exemplified by the menu screens illustrated in FIGS. 9A to 9D is displayed without non-contact communication, and non-contact communication of the information terminal 1 with the electronic tag 2 in proximity thereto is performed when the user operates the menu screen and controls the electrical appliance 3. In this case, as illustrated in FIGS. 4A to 4D, it is preferable to display, on the display unit 16 of the information terminal 1, an indication indicating that display and operation are disabled, a reason for the incapability, and a countermeasure at a time when a menu screen is displayed. This makes it possible to enhance the user's convenience.

As described above, according to the embodiment, it is possible to display a menu screen that is displayable or controllable depending on a state of the electrical appliance 3, when non-contact communication is performed between the electrical appliance 3, and the information terminal 1 which displays the state of the electrical appliance 3 and controls the operation of the electrical appliance 3. This makes it easy for the user to operate the information terminal 1, and to enhance the user's operability.

The latter part of the processing of Step S14 in FIG. 2 is described referring to the flowchart of FIG. 3.

In Step S14, the display unit 16 displays menu information (menu screen) created by the menu creation unit 17. In Step S15, the operation unit 15 of the information terminal 1 accepts a user's operation with respect to the electrical appliance 3. The user inputs an intended control with respect to the electrical appliance 3 with use of the operation unit 15 of the information terminal 1. For instance, the user selects an intended item from among the items on a menu screen to be displayed on the display unit 16.

The wireless communication unit 11 of the information terminal 1 performs wireless communication with the wireless communication unit 21 of the electronic tag 2.

Subsequently, in Step S16, the wireless communication unit 11 of the information terminal 1 transmits, to the electronic tag 2, appliance control information of the electrical appliance 3 (a result obtained by the processing of Step S15).

Subsequently, in Step S17, the wireless communication unit 21 of the electronic tag 2 receives the appliance control information transmitted from the information terminal 1, and the wired communication unit 22 transmits the received appliance control information to the electrical appliance 3.

As a method for transmitting appliance control information from the information terminal 1 to the electrical appliance 3 via the electronic tag 2, there are proposed a method, in which the information terminal 1 writes appliance control information in the storage unit 25 of the electronic tag 2, and then, the electrical appliance 3 reads the appliance control information from the storage unit 25 of the electronic tag 2; and a method, in which appliance control information is transmitted from the wired communication unit 22 to the electrical appliance 3, while the appliance control information is received from the information terminal 1 without using the storage unit 25 of the electronic tag 2. The latter method makes it possible to shorten the communication time, and is advantageous in shortening an operation time of a one-time non-contact communication (the processing time required from Step S16 to Step S23).

Subsequently, in Step S18, the transmitting/receiving unit 31 of the electrical appliance 3 receives the appliance control information transmitted by the electronic tag 2.

Subsequently, in Step S19, the appliance control unit 33 accepts the appliance control information received by the transmitting/receiving unit 31.

Subsequently, in Step S20, the appliance control unit 33 sets control result information representing whether the appliance control information is accepted.

Subsequently, in Step S21, the transmitting/receiving unit 31 transmits, to the electronic tag 2, the control result information representing whether the appliance control information is accepted by the electrical appliance 3. Subsequently, in Step S22, the wired communication unit 22 of the electronic tag 2 receives the control result information transmitted from the electrical appliance 3, and the wireless communication unit 21 transmits the received control result information to the information terminal 1.

Subsequently, in Step S23, the wireless communication unit 11 of the information terminal 1 receives the control result information transmitted from the electronic tag 2. Also regarding Step S23, as a method for transmitting control result information from the electronic appliance 3 to the information terminal 1 via the electronic tag 2, there are proposed a method, in which the electrical appliance 3 writes control result information in the storage unit 25 of the electronic tag 2, and then, the information terminal 1 reads the control result information from the storage unit 25 of the electronic tag 2; and a method, in which control result information is transmitted from the wireless communication unit 21 to the information terminal 1, while the control result information is received from the electrical appliance 3 without using the storage unit 25 of the electronic tag 2.

The processing from Step S16 to Step S23 corresponds to a one-time non-contact communication operation of holding the information terminal 1 close to the electronic tag 2.

Subsequently, in Step S24, the display unit 16 of the information terminal 1 displays control result information representing a control of the electrical appliance 3.

When appliance control information is accepted in Step S19, in Step S25, the appliance control unit 33 of the electrical appliance 3 controls the electrical appliance 3 to operate based on the received appliance control information.

Subsequently, in Step S26, the appliance state determination unit 34 determines an operation state of the electrical appliance 3. In this case, the operation state of the electrical appliance 3 is changed by the control operation of the appliance in Step S25. The appliance state determination unit 34 determines whether the electrical appliance 3 is in a state capable of accepting setting information or control information relating to an operation, as a result of accessing the electrical appliance 3 from the electronic tag 2.

When it is determined that the electrical appliance 3 is in a state incapable of accepting setting information or control information relating to an operation, as a result of accessing the electrical appliance 3 from the electronic tag 2, the menu creation information control unit 32 sets menu creation information including one of the first to fourth menu creation disable information items in the menu creation information storage unit 23 of the electronic tag 2 via the transmitting/receiving unit 31 and via the wired communication unit 22.

On the other hand, when it is determined that the electrical appliance 3 is in a state capable of accepting setting information or control information relating to an operation, as a result of accessing the electrical appliance 3 from the electronic tag 2, the menu creation information control unit 32 sets menu creation information including one of the first to fourth menu creation instruction information items in the menu creation information storage unit 23 via the transmitting/receiving unit 31 and via the wired communication unit 22.

Specifically, when it is determined that the electrical appliance 3 is in a state incapable of accepting setting information or control information relating to an operation, as a result of accessing the electrical appliance 3 from the electronic tag 2, in Step S27, the menu creation information control unit 32 creates menu creation information including menu creation disable information. Further, when it is determined that the electrical appliance 3 is in a state capable of accepting information or control information relating to an operation, as a result of accessing the electrical appliance 3 from the electronic tag 2, in Step S27, the menu creation information control unit 32 creates menu creation information including menu creation instruction information.

Subsequently, in Step S28, the transmitting/receiving unit 31 transmits, to the electronic tag 2, the menu creation information created by the menu creation information control unit 32. Subsequently, in Step S29, the wired communication unit 22 of the electronic tag 2 receives the menu creation information transmitted from the electrical appliance 3, and stores the received menu creation information in the menu creation information storage unit 23.

Subsequently, in Step S30, the display unit 35 of the electrical appliance 3 displays that the menu creation information is one of the first to fourth menu creation disable information items and the first to fourth menu creation instruction information items, and notifies the user of the information.

Subsequently, in Step S31, the display unit 26 of the electronic tag 2 displays that the menu creation information is one of the first to fourth menu creation disable information items and the first to fourth menu creation instruction information items, and notifies the user of the information. The display unit 26 and the display unit 35 are LEDs (light emitting diodes), for instance, and notify the user by display color light or by blinking of light. Alternatively, one of the display unit 35 of the electrical appliance 3 and the display unit 26 of the electronic tag 2 may display that the menu creation information is one of the first to fourth menu creation disable information items and the first to fourth menu creation instruction information items. Further alternatively, both of the display unit 35 of the electrical appliance 3 and the display unit 26 of the electronic tag 2 may be inoperative to display that the menu creation information is one of the first to fourth menu creation disable information items and the first to fourth menu creation instruction information items.

In the embodiment, the menu creation information control unit 32 of the electrical appliance 3 creates menu creation information including menu creation instruction information or menu creation disable information in accordance with a state of the appliance, and stores the menu creation information in the menu creation information storage unit 23 of the electronic tag 2. Further, the menu creation unit 17 of the information terminal 1 acquires the menu creation information, creates menu information, and displays a menu screen. The invention is not limited to the above configuration.

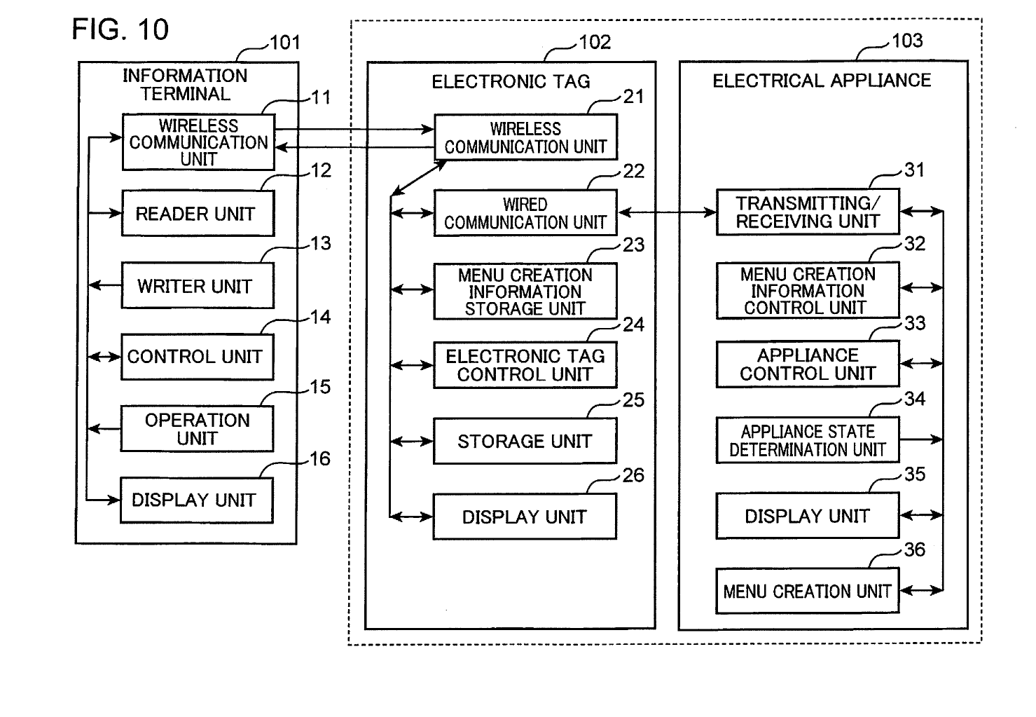

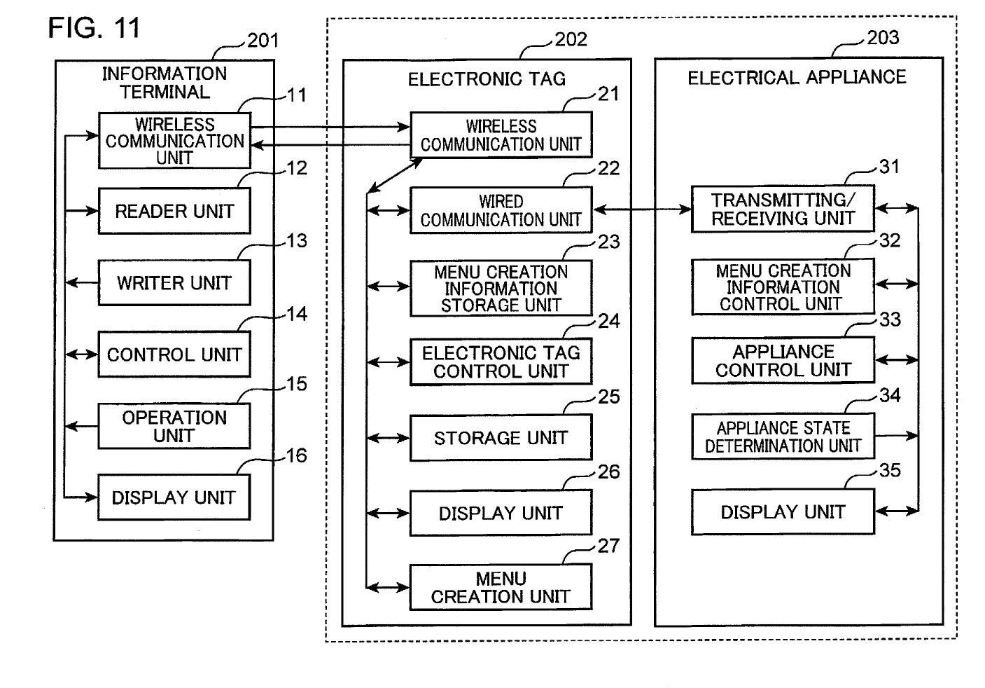

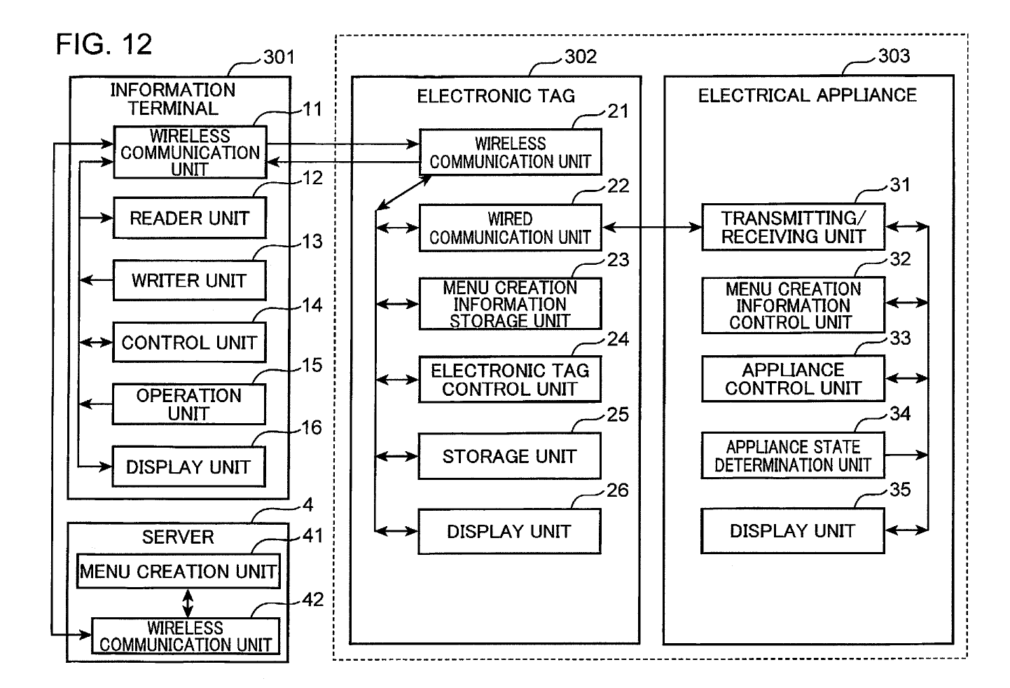

Another configuration example of the wireless communication system is described referring to FIG. 10, FIG. 11, and FIG. 12. In FIG. 10, FIG. 11, and FIG. 12, the same elements as those of the wireless communication system illustrated in FIG. 1 are indicated with the same reference signs, and detailed description thereof is omitted.

FIG. 10 is a diagram illustrating an entire configuration of a wireless communication system as a first modification of the embodiment of the invention. The wireless communication system as the first modification of the embodiment is such that an electrical appliance 103 is provided with a menu creation unit 36. Whereas the wireless communication system in FIG. 1 creates menu information in the inside of the information terminal 1, the wireless communication system in FIG. 10 creates menu information in the inside of the electrical appliance 103.

The wireless communication system illustrated in FIG. 10 is provided with an information terminal 101, an electronic tag 102, and the electrical appliance 103. The information terminal 101 is provided with a wireless communication unit 11, a reader unit 12, a writer unit 13, a control unit 14, an operation unit 15, and a display unit 16. The electronic tag 102 is provided with a wireless communication unit 21, a wired communication unit 22, a menu creation information storage unit 23, an electronic tag control unit 24, a storage unit 25, and a display unit 26. The electrical appliance 103 is provided with a transmitting/receiving unit 31, a menu creation information control unit 32, an appliance control unit 33, an appliance state determination unit 34, a display unit 35, and a menu creation unit 36.

The configuration as to how the appliance state determination unit 34 of the electrical appliance 103 determines a state of the appliance is the same as the configuration described referring to FIG. 1. The menu creation unit 36 of the electrical appliance 103 creates menu information in accordance with a determination result of the appliance state determination unit 34, and transmits the created menu information to the information terminal 101 via the menu creation information storage unit 23 of the electronic tag 102. The display unit 16 of the information terminal 101 displays the received menu information.

Further, FIG. 11 is a diagram illustrating an entire configuration of a wireless communication system as a second modification of the embodiment of the invention. The wireless communication system as the second modification of the embodiment is such that an electronic tag 202 is provided with a menu creation unit 27. Whereas the wireless communication system in FIG. 1 creates menu information in the inside of the information terminal 1, the wireless communication system in FIG. 11 creates menu information in the inside of the electronic tag 202.

The wireless communication system illustrated in FIG. 11 is provided with an information terminal 201, the electronic tag 202, and an electrical appliance 203. The information terminal 201 is provided with a wireless communication unit 11, a reader unit 12, a writer unit 13, a control unit 14, an operation unit 15, and a display unit 16. The electronic tag 202 is provided with a wireless communication unit 21, a wired communication unit 22, a menu creation information storage unit 23, an electronic tag control unit 24, a storage unit 25, a display unit 26, and the menu creation unit 27. The electrical appliance 203 is provided with a transmitting/receiving unit 31, a menu creation information control unit 32, an appliance control unit 33, an appliance state determination unit 34, and a display unit 35.

The configuration as to how the appliance state determination unit 34 of the electrical appliance 203 determines a state of the appliance, and the menu creation information control unit 32 stores the menu creation information in the menu creation information storage unit 23 of the electronic tag 2 is the same as the configuration described referring to FIG. 1. The menu creation unit 27 of the electronic tag 202 creates menu information in accordance with the menu creation information, and transmits the menu information to the information terminal 201 via the menu creation information storage unit 23. The display unit 16 of the information terminal 201 displays the received menu information.

Further, FIG. 12 is a diagram illustrating an entire configuration of a wireless communication system as a third modification of the embodiment of the invention. The wireless communication system illustrated in FIG. 12 is provided with an information terminal 301, an electronic tag 302, an electrical appliance 303, and a server 4. The information terminal 301 is provided with a wireless communication unit 11, a reader unit 12, a writer unit 13, a control unit 14, an operation unit 15, and a display unit 16. The electronic tag 302 is provided with a wireless communication unit 21, a wired communication unit 22, a menu creation information storage unit 23, an electronic tag control unit 24, a storage unit 25, and a display unit 26. The electrical appliance 303 is provided with a transmitting/receiving unit 31, a menu creation information control unit 32, an appliance control unit 33, an appliance state determination unit 34, and a display unit 35. The server 4 is provided with a menu creation unit 41 and a wireless communication unit 42.

In the wireless communication system illustrated FIG. 1, the menu creation unit 17 of the information terminal 1 acquires menu creation information, creates menu information, and displays a menu screen. On the other hand, in the wireless communication system illustrated in FIG. 12, the information terminal 301 is connectable to the server 4 via a communication network, and the server 4 is provided with the menu creation unit 41 and the wireless communication unit 42. The wireless communication unit 42 of the server 4 receives menu creation information from the information terminal 301. The menu creation unit 41 creates menu information, and transmits the created menu information to the information terminal 301. The display unit 16 of the information terminal 301 displays the received menu information.

The wireless communication unit 42 acquires the menu creation information created in accordance with a state of the electrical appliance 303 from the electrical appliance 303 via the information terminal 301. The menu creation unit 41 creates menu information relating to an operation of the electrical appliance 303 or relating to a service of the electrical appliance 303, based on the menu creation information acquired by the wireless communication unit 42. The wireless communication unit 42 transmits, to the information terminal 301, the menu information created by the menu creation unit 41.

In the embodiment, the information terminal 301 and the server 4 are wirelessly connected to be communicable with each other via a network. Alternatively, the information terminal 301 and the server 4 may be wiredly connected to be communicable with each other via a network. When the information terminal 301 and the server 4 are wiredly connected, the information terminal 301 is provided with a wired communication unit, and the server 4 is provided with a wired communication unit.

As described above, the third modification is advantageous in reducing the load on hardware resources of the information terminal 301, when the server 4 executes a program for creating menu information. Further, as far as the information terminal 301 is connectable to the server 4 via a communication network, the server 4 may perform a part of the processing to be performed by the information terminal in the embodiment, in other words, may perform processing other than the processing of creating menu information.

As described above, a device provided with a menu creation unit which creates menu information may be any one of the information terminal 1, the electronic tag 2, the electrical appliance 3, and the server 4. However, in order to display menu information in conformity to the screen specifications of a variety of types of information terminals, as illustrated in FIG. 1 or FIG. 2, it is advantageous to provide a configuration, in which the information terminal 1 or the server 4 creates menu information. It is not necessary to provide a menu creation unit in each of the electrical appliance and the electronic tag.

Further, when the operation unit 15 of the information terminal 1 is operated, and a menu screen is displayed, without performing non-contact communication of the information terminal 1 with the electronic tag 2 in proximity thereto, as illustrated in FIGS. 9A to 9D, the number of menu items may increase, and the depth of a layer corresponding to the menu item which the user wishes to operate may increase. This may lower the operability.

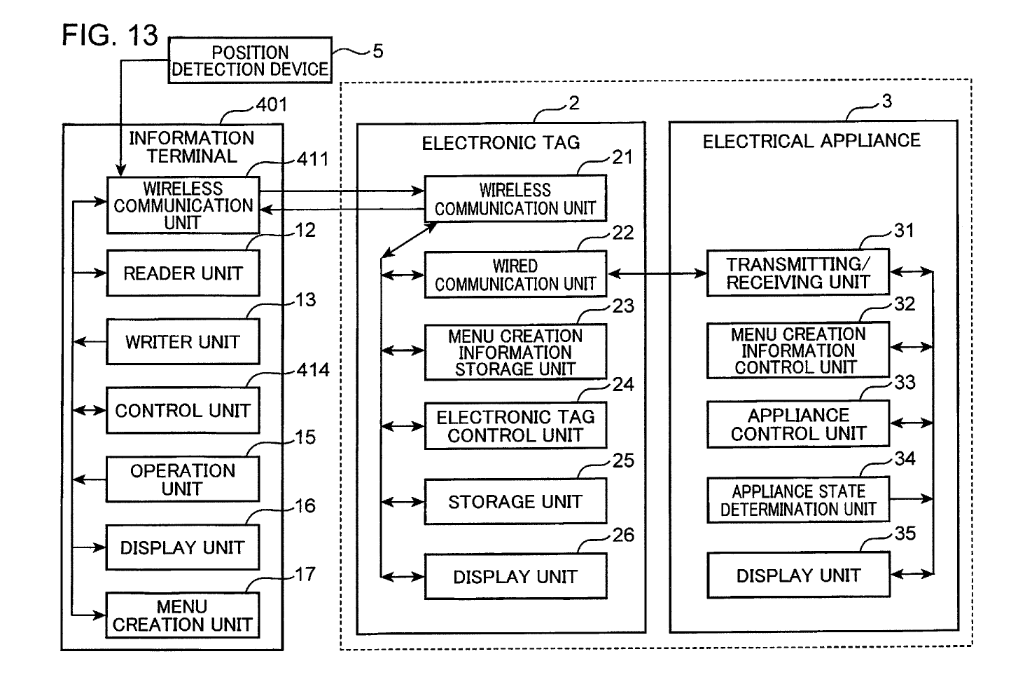

In view of the above, there is proposed a wireless communication system as illustrated in FIG. 13, in which a position detection device 5 is additionally provided in the wireless communication system in FIG. 1.

FIG. 13 is a diagram illustrating an entire configuration of a wireless communication system as a fourth modification of the embodiment of the invention. The wireless communication system illustrated in FIG. 13 is provided with an information terminal 401, an electronic tag 2, an electrical appliance 3, and a position detection device 5. The information terminal 1 is provided with a wireless communication unit 411, a reader unit 12, a writer unit 13, a control unit 414, an operation unit 15, a display unit 16, and a menu creation unit 17. The electronic tag 2 is provided with a wireless communication unit 21, a wired communication unit 22, a menu creation information storage unit 23, an electronic tag control unit 24, a storage unit 25, and a display unit 26. The electrical appliance 3 is provided with a transmitting/receiving unit 31, a menu creation information control unit 32, an appliance control unit 33, an appliance state determination unit 34, and a display unit 35.

The position detection device 5 is a base station of a public network when the information terminal 1 is a smartphone or a mobile phone, for instance. The wireless communication unit 411 of the information terminal 401 wirelessly communicates with the position detection device 5, which is a base station of a public network. According to this configuration, the control unit 414 is capable of judging the current position of the information terminal 401, and is capable of judging whether the information terminal 401 is present within the range of from several meters to several ten meters from home.

Further, the position detection device 5 may be a GPS (Global Positioning System) device. In this case, the wireless communication unit 411 of the information terminal 401 is capable of receiving a wireless signal from the position detection device 5 as a GPS satellite. Further, the control unit 414 is capable of judging the current position of the information terminal 401, and is capable of judging whether the information terminal 401 is present within the range of from several meters to several ten meters from home.

Further, the position detection device 5 may be a wireless LAN base unit installed at home. In this case, the wireless communication unit 411 of the information terminal 401 is capable of receiving a radio wave from the wireless LAN base unit. Further, the control unit 414 is capable of judging the current position of the information terminal 401, and is capable of judging whether the information terminal 401 is present within the range of from several meters to several ten meters from home.

The wireless communication unit 411 performs communication with the position detection device 5 which detects the position of the information terminal 401, and acquires the position of the information terminal 401 detected by the position detection device 5.

The control unit (position judgment unit) 414 judges whether the positon of the information terminal 401 acquired by the wireless communication unit 411 lies within a predetermined range with respect to the position of the electronic tag 2.

When the control unit 414 judges that the position of the information terminal 401 does not lie within a predetermined range with respect to the position of the electronic tag 2, the menu creation unit 17 creates menu information, in which a menu item requiring proximity communication with the electronic tag 2 is deleted.

In this way, when it is judged whether the information terminal 401 lies within a predetermined range from home where the electrical appliance 3 and the electronic tag 2 are installed by wireless communication with the position detection device 5, and it is judged that the information terminal 401 is out of the predetermined range from home, the position of the information terminal 401 is not a position capable of performing non-contact communication with the electronic tag 2. Therefore, the menu creation unit 17 deletes, from the menu information, a predetermined menu item relating to an operation or a service of the electrical appliance requiring non-contact communication with the electronic tag 2.

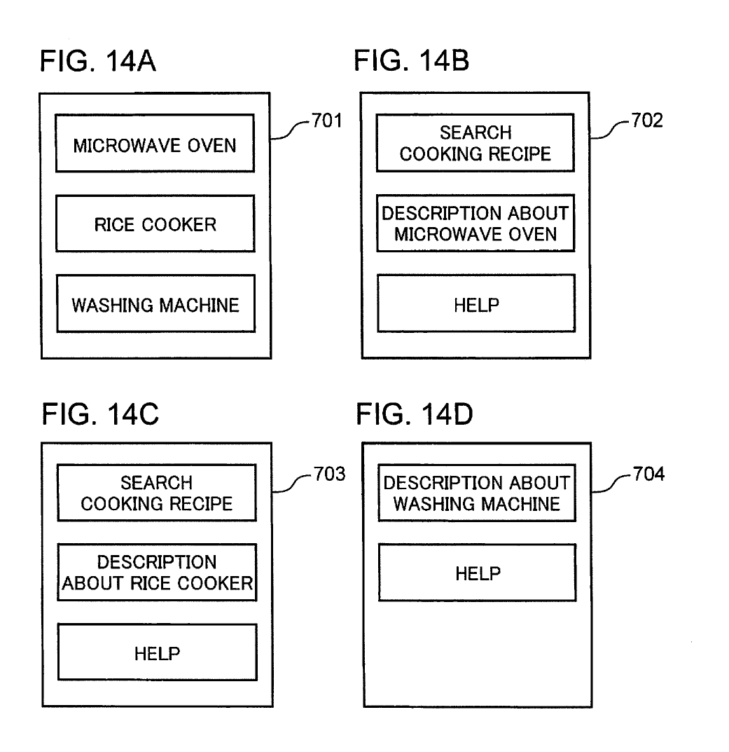

Specifically, when it is judged that the information terminal 401 lies within a predetermined range from home, the menu creation unit 17 creates the same menu information as illustrated in FIGS. 9A to 9D. FIGS. 14A to 14D illustrate menu screens to be displayed when it is judged that the information terminal 401 is out of a predetermined range from home.

FIG. 14A is a diagram illustrating an example of a menu screen to be displayed when an information terminal is out of a predetermined range from home, and an electrical appliance is selected. FIG. 14B is a diagram illustrating an example of a menu screen to be displayed when a microwave oven is selected in FIG. 14A. FIG. 14C is a diagram illustrating an example of a menu screen to be displayed when a rice cooker is selected in FIG. 14A. FIG. 14D is a diagram illustrating an example of a menu screen to be displayed when a washing machine is selected in FIG. 14A.

A menu screen 701, as illustrated in FIG. 14A, on which the user is allowed to select an electrical appliance, is the same as illustrated in FIG. 9A. On the other hand, a menu item requiring communication between the information terminal 1 and the electronic tag 2 of the electrical appliance 3, such as control of the electrical appliance 3 and acquisition of an operation state of the electrical appliance 3, is not displayed on menu screens 702 to 704 illustrated in FIG. 14B, FIG. 14C, and FIG. 14D.

In this way, it is possible to judge the current position of the information terminal 1. This is advantageous in enhancing the user's operability of a menu screen when the user is not at home.

The aforementioned embodiment may be carried out by a computer and a computer program.

Further, in the embodiment, examples of the electrical appliance are a microwave oven, a rice cooker, and a washing machine. The electrical appliance is not limited to these household electrical appliances. As far as the electrical appliance is an appliance configured to communicate with an information terminal, any electrical appliance such as a business machine and a facility equipment may be used.

The exemplary embodiment or examples described in the section of description of embodiments are provided to clarify the technical contents of the invention. The invention should not be construed to be limited to the exemplary embodiment or examples. The invention may be modified in various ways as far as such modifications do not depart from the spirit and the scope of the invention hereinafter defined.

### INDUSTRIAL APPLICABILITY

As described above, an information terminal of the invention makes it easy for the user to operate the information terminal, and makes it possible to enhance the user's operability. Thus, the information terminal of the invention is advantageously used as an information terminal which displays a state of an appliance and controls an operation of the appliance.

1. An information terminal for displaying a state of an appliance and controlling an operation of the appliance, comprising:
a wireless communication unit which performs proximity communication with a proximity communication device provided in the appliance, and acquires menu creation information created in accordance with a state of the appliance;
a menu creation unit which creates menu information relating to an operation of the appliance or relating to a service of the appliance, based on the menu creation information acquired by the wireless communication unit; and
a display unit which displays the menu information created by the menu creation unit.

2. The information terminal according to claim 1, wherein
the menu creation unit creates menu information relating to a setting state of the appliance or relating to operation settings of the appliance when a state of the appliance represents that the appliance is in an inoperative state.

3. The information terminal according to claim 1, wherein
the menu creation unit creates menu information relating to an operation state of the appliance or relating to an operation change of the appliance when a state of the appliance represents that the appliance is in an operated state.

4. The information terminal according to claim 1, wherein
the menu creation unit creates menu information relating to an operation result of the appliance or relating to operation contents of the appliance when a state of the appliance represents that a current time is within a predetermined time period after the operation of the appliance is finished.

5. The information terminal according to claim 1, wherein
the menu creation unit creates menu information relating to error contents of the appliance or relating to fault contents of the appliance when a state of the appliance represents that the appliance is in an error state or in a faulty state.

6. The information terminal according to claim 1, wherein
when the wireless communication unit performs proximity communication with the proximity communication device in a state that communication processing between the proximity communication device and the appliance is disabled, the menu creation unit creates menu information relating to a reason for the incapability of communication processing, in place of creating menu information relating to an operation of the appliance or relating to a service of the appliance.

7. The information terminal according to claim 1, wherein
the wireless communication unit performs communication with a position detection device which detects a position of the information terminal, and acquires the position of the information terminal detected by the position detection device,
the information terminal further comprises a position judgment unit which judges whether the position of the information terminal acquired by the wireless communication unit lies within a predetermined range with respect to a position of the proximity communication device, and
the menu creation unit creates menu information in which a menu item requiring proximity communication with the proximity communication device is deleted, when the position judgment unit judges that the position of the information terminal is out of the predetermined range with respect to the position of the proximity communication device.

8. An information display method for displaying menu information relating to an operation of an appliance or relating to a service of the appliance, comprising:
a step of detecting a state of the appliance;
a step of creating menu creation information in accordance with a state of the appliance;
a step of creating menu information based on the menu creation information; and
a step of displaying the menu information.

9. A non-transitory computer readable recording medium storing a control program for an information terminal which displays a state of an appliance and controls an operation of the appliance, the control program causing a computer to function as:
a wireless communication unit which performs proximity communication with a proximity communication device provided in the appliance, and acquires menu creation information created in accordance with a state of the appliance;
a menu creation unit which creates menu information relating to an operation of the appliance or relating to a service of the appliance, based on the menu creation information acquired by the wireless communication unit; and
a display unit which displays the menu information created by the menu creation unit.

10. A server for communicating with an information terminal which displays a state of an appliance and controls an operation of the appliance, comprising:
an acquisition unit which acquires menu creation information created in accordance with a state of the appliance from the appliance via the information terminal;
a menu creation unit which creates menu information relating to an operation of the appliance or relating to a service of the appliance, based on the menu creation information acquired by the acquisition unit; and
a transmitting unit which transmits the menu information created by the menu creation unit to the information terminal.
